(19) United States
(12) Patent Application Publication
(10) Pub. No.: US 2018/0074934 A1
(43) Pub. Date: Mar. 15, 2018

(54) METHOD FOR CHECKING EQUIVALENCE OF CODE, NON-TRANSITORY COMPUTER-READABLE STORAGE MEDIUM, COMPUTER PROGRAM PRODUCT AND COMPUTER FOR IMPLEMENTING THE METHOD

(71) Applicant: AREVA NP SAS, COURBEVOIE (FR)

(72) Inventors: RICHARD KRECKEL, ERLANGEN (DE); ANDREAS KUENZEL, HERZOGENAURACH (DE)

(21) Appl. No.: 15/797,446

(22) Filed: Oct. 30, 2017

Related U.S. Application Data
(63) Continuation of application No. PCT/EP2016/059479, filed on Apr. 28, 2016.

(30) Foreign Application Priority Data
Apr. 29, 2015 (EP) 15165729.3

(51) Int. Cl. G06F 11/36; G06F 9/45; G06F 9/44; G05B 9/02

(52) U.S. Cl. CPC G06F 11/36; G06F 8/433; G21D 3/04; G06F 8/427; G05B 9/02; G06F 8/71

(57) ABSTRACT

A method checks the functional equivalence of two pieces of software for control systems, engineered from function block diagram with a plurality of interconnected function blocks. The method includes a) generating a first instance of compilable source code; b) parsing the first instance of source code; c) using the information from step b) to reconstruct a first data flow graph of the first instance of source code; d) generating a second instance of compilable source code from a second plurality of function block diagrams; e) parsing the second instance of source code; f) using the information from step e) to reconstruct a second data flow graph of the second instance of source code; g) comparing the first identified data flow graph and the second identified data flow graph, and checking if the transitive closure of input up to that node in the second instance of source code is the same.

### CROSS-REFERENCE TO RELATED APPLICATION

This application is a continuation, under 35 U.S.C. § 120, of copending international application No. PCT/EP2016/059479, filed Apr. 28, 2016, which designated the United States; this application also claims the priority, under 35 U.S.C. § 119, of European patent application No. EP 15165729.3, filed Apr. 29, 2015; the prior applications are herewith incorporated by reference in their entirety.

### BACKGROUND OF THE INVENTION

### Field of the Invention

The invention relates to a method for checking the functional equivalence of two pieces of software for safety control systems. It relates to control systems with source code automatically generated from function block diagrams. It also relates to a non-transitory computer-readable storage device. It further relates to a non-transitory computer-readable storage medium. It also relates to a computer program product, a system and a computer.

For the safe and reliable operation of nuclear power plants or other safety-critical systems, electricity and control systems are of paramount importance, especially safety instrumentation & control (I&C) systems. For a given digital safety I&C system with possibly multiple redundant divisions and an engineering system which lets the system engineer specify the software using function block diagrams (FBDs) in multiple subsequent versions, the software needs to be validated for each redundant division and for each version until all acceptance criteria are met.

The overhead of validating each redundant division and each version is considerably large if one considers that there will be significant similarities: Some FBDs will be basically the same in different redundant divisions, only some FBDs will have changed from one version to the next one. Manual modifications to FBDs (on different redundant divisions or from one version to another) have a tendency to alter the generated code in a way that amplifies the differences in the generated code between these versions. This makes it generally impossible to pinpoint the differences in the generated codes.

Up to now all FBDs have to undergo verification and validation (V&V) activities even if their functionality was unchanged. During development or verification and validation of application software, the task might arise to verify that two FBDs are functionally equivalent in order to omit redundant verification of validation activities for functionally equivalent FBDs. The need for this task might be caused by the need to identify function block diagrams which implement the same functions in different redundancies or the need to identify function block diagrams that have changed between different versions of an application.

In order to determine, whether one diagram implements the same functionality as another diagram, a simple line-by-line differences of the source codes of the two diagrams can raise many false positives. This is because the code generator has several degrees of freedom when generating source code for function block diagrams. There might be differences in the source codes ranging from different identifiers for symbols up to a different sequentialization of the function block calls. However, even with these differences, the functionality, i.e. the observable behavior, of the diagrams can be the same. This makes “back-translation” of the generated computer code, for example C code, to function block diagrams within the engineering database very complicated.

### SUMMARY OF THE INVENTION

The object of the present invention therefore is to provide a method which reliably and accurately allows determining the equivalence of two different pieces of generated FBD source code.

In a first aspect, the invention relates to a method for checking the functional equivalence of two pieces of software for control systems, in particular control systems based on programmable logic controllers, engineered from function block diagrams with a plurality of interconnected function blocks. The method includes the following steps:

a) generating a first instance of compilable source code from a first plurality of function block diagrams by virtue of a first code generator obeying to a first set of sequentialization rules;
b) parsing the first instance of source code and identifying the set of all function block I/O ports and junction points (nodes) and the set of all connections between them (arcs) of the data flow;
c) using the information from step b) to reconstruct a first data flow graph of the first instance of source code in the upstream direction;
d) generating a second instance of compilable source code from a second plurality of function block diagrams by virtue of the same or a second code generator obeying a second set of sequentialization rules;
e) parsing the second instance of source code and identifying the set of all function block I/O ports and junction points (nodes) and the set of all connections between them (arcs) of the data flow;
f) using the information from step e) to reconstruct a second data flow graph of the second instance of source code in the upstream direction;
g) comparing the first identified data flow graph and the second identified data flow graph with each other, node-by-node, and thereby checking if the transitive closure of input up to that node in the second instance of source code is the same as in the first instance of source code.

The invention is based on the consideration that a simple comparison of the differences of two source codes generated from FBD is not efficient due to possibility of many false positives due to freedom in the code generation, for example in the sequentialization of the function blocks used in the diagram. It would therefore be desirable to have a procedure which abstracts from these differences but maintains the essential information.

Applicant has recognized that a reliable and accurate comparison of two pieces of computer code can be achieved by generating data graphs from the code blocks which contain incoming and outgoing data. The method according to the present invention can reliably determine if parts of two I&C specifications are guaranteed to have the same behavior, even if they span multiple FBDs. It achieves this by parsing the generated (C or any other formally specified) code and traversing the data flow graph for each function block (FB) in the upstream direction. If all upstream FBs are of the same type, have the same parameters, and are linked with other FBs or input signals by equivalent vertices, then they perform the same I&C function. In this way it is possible to prove that two compared sets of FBDs are functionally equivalent.

The method according to the present invention comprises transforming the generated code of FBDs, which is a directed multigraph, into a directed graph which can uniquely model the functionality implemented by the FBD. The representation of the graph is done in a way which allows a unique identification of each node and each vertex in the graph by including all relevant functional properties and the transitive closure of inputs up to each node. This allows a comparison of different FBDs to prove whether they implement the same functionality or not.

The method is a computer-implemented method which runs on a computer, preferably allowing a user to interact with it and preferably connected to a display device on which the user gets shown the result of the code comparison.

In a preferred embodiment, constructing the first data graph in the upstream direction includes identifying all loops and replacing them with a placeholder such that an infinite recursion is stopped at the loops' delay nodes.

In another preferred embodiment, constructing the second data graph in the upstream direction includes identifying all loops and replacing them with a placeholder such that an infinite recursion is stopped at the loops' delay nodes.

Preferably, a first and/or second plurality of function block diagrams by virtue of the respective first code generator is generated into source code in the C computer language.

Preferably the second set of sequentialization rules is identical to the first set of sequentialization rules.

Advantageously, the first and/or second data graph comprises nodes of the following types:

a) function block nodes, representing the body of a function block;
b) function block port nodes, representing input or output ports of function blocks;
c) signal negator nodes, representing the negation of an analog or binary or other type of signal connected at a port of a function block; and
d) signal nodes, representing cross-diagram signals or signals assigned to I/O modules.

Function block nodes preferably include as attributes, respectively, the function block type and functionally relevant engineered parameter values, and whereby function block port nodes include as attributes, respectively, the direction of the port (input or output for the function block) and a number identifying the port of the respective function block.

Preferably the method described above is employed for safety control system, for example in nuclear power plants.

Advantageously, the method described above is employed for a safety control system containing several redundant divisions, each division executing at least one safety function specified in at least one function block diagram.

In a second aspect, the present invention relates to a non-transitory computer-readable storage device, coupled to a computer and having instructions stored thereon which, when executed on the computer, enable and/or cause the computer to perform operations for checking the functional equivalence of two pieces of software for control systems, the operations containing an above described method.

In a third aspect the present invention relates to a non-transitory computer-readable storage medium containing instructions which, when loaded into memory of and executed on a computer, enable and/or cause the computer to perform operations for checking the functional equivalence of two pieces of software for control systems, the operations containing an above described method.

In yet another aspect, the present invention relates to a computer program product which is stored on a non-transitory computer-readable medium such as a flash disk, CD, DVD, hard disk and can be loaded directly into memory of a computer, comprises software code sections which when executed on the computer enables and/or causes said computer to perform a method described above.

In yet another aspect, the invention relates to a system includes at least one computing device and a non-transitory computer-readable storage device, coupled to the computing device and having instructions stored thereon which, when executed on the computer, enable and/or cause the computer to perform operations for checking the functional equivalence of two pieces of software for control systems, the operations containing the method described above.

In yet another aspect, the invention relates to a computer containing memory having stored thereon software code sections which when executed on the computer enable and/or cause the computer to perform a method described above.

The advantages of the invention are especially as follows. It is advantageous to work on generated code as opposed as to work on the graphical specification because in a regulated environment this is closer to the final product and avoids questions regarding the reliability of the translation step from graphical specification to code (the code generation). It is another advantage to be able to fully reconstruct the dataflow graph as opposed as to working FB by FB (as has been done by previous tools) because this captures all input data and hence makes a statement that “this piece of software does the same as that piece of software” 100% reliable.

Other features which are considered as characteristic for the invention are set forth in the appended claims.

Although the invention is illustrated and described herein as embodied in a method for checking equivalence of code, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram of protection functions in a safety control system according to the invention;

FIG. 2 is a diagram of function blocks and two different sequentializations of function blocks in the generated source code of this diagram:

FIG. 3 is an illustration showing a comparison of generated FBD source codes using their graph representation;

FIG. 4 is a first function block diagram containing function blocks, connection lines and a signal negation;

FIG. 5 is a visual representation of a graph modeling the function block diagram of FIG. 4;

FIG. 6 is a second function block diagram containing function blocks and connection lines; and

FIG. 7 is a visual representation of a graph modeling the function block diagram of FIG. 6.

### DETAILED DESCRIPTION OF THE INVENTION

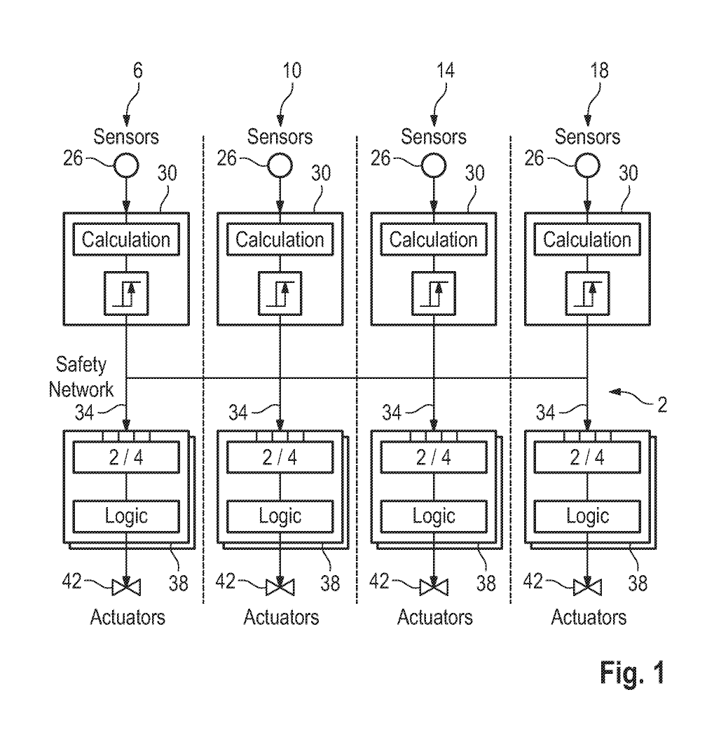

Referring now to the figures of the drawings in detail and first, particularly to FIG. 1 thereof, there is shown a typical structure 2 of protection functions. It consists of a set of I&C functions 6, 10, 14, 18 implemented in multiple redundancies in a control system for a nuclear power plant. A first of these functions 6 receives a signal from one or more sensors 26 which is then processed in a computational block 30. The calculated result is then passed through a safety network 34 to another computational block 38 in which it is processed into a signal for controlling one or more actuators 42. The other functions 10, 14, 18 are realized in the same manner.

In order to implement functionality with multiple redundancies, the corresponding function block diagrams for functions 6, 10, 14, 18 are implemented multiple times. In a typical protection system, certain diagrams have to be implemented up to four times to implement such redundant division even though the logic implemented by these diagrams is the same. For these function block diagrams, code is generated independently which results in four different source codes implementing equivalent functionality.

In a preferred embodiment of the method, function block diagrams are converted from an engineering database to ANSI C code by a code generator. In order to have unique identifiers in the generated source codes, two function block diagrams of one specification differ at least in naming of symbols. For example, symbols related to a function block diagram include the internal numerical ID of the diagram within their name. Additionally, identifiers in the generated code can also differ between two revisions of one diagram's source code. Reasons might be changes to the diagram itself, as well as changes to signals interconnecting diagrams. This is due to the fact that symbols in the generated codes may use internal database keys of the employed database that cannot be engineered. One example is specification-wide unique identifiers of cross-diagram signals.

The following samples show parts of function block diagram source codes, using numerical diagram IDs (number 99) and numerical signal IDs (number 1111).

void i_fd_99_Compute(void)

{

static const fb_257_t locFb_1={/* FB: “SINK-2”, Type: “SINK” */

fd_99 FbExtIdents.id_257, /* Page: 1, Position: 3B */

&i_fd_99_CSignals.asZ_1111, /* Source: Signal “10 READ A021” */

&fd_99_USignals.bs_257_2,

. . .

}

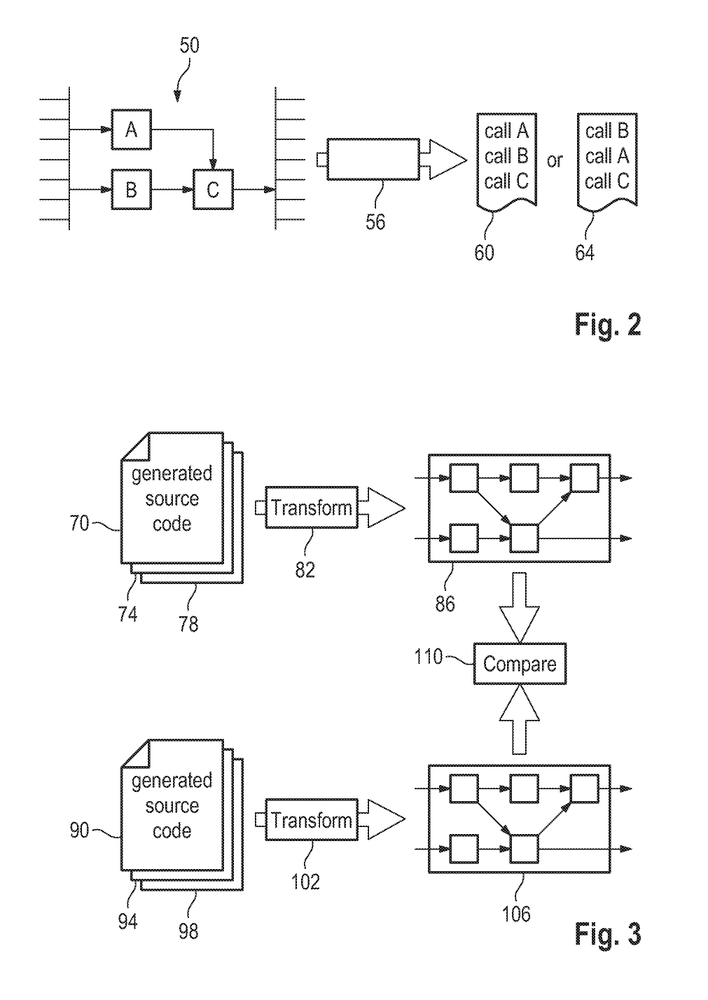

Another point where two functionally identical diagrams can differ in their source code is the sequentialization of function block calls. The same diagram can result in different permutations of function block sequentialization while still being functionally equivalent (i.e. have the same observable behavior). For example, in FIG. 2 a very simple diagram 50 is shown with three different function calls A, B, and C which can, when converted into source code by a code generator 56, result in two sequentializations 60, 64 which both correctly implement the diagram. In sequentialization 60, first function A is called, then function B is called and then function C is called. In sequentialization 64, first function B is called, then function A is called and then function C is called.

The following samples show parts of function block diagram source code containing IDs depending on the sequentialization of the function blocks.

static const fb_123_t locFb_0={ . . . };

static const fb_321_t locFb_1={ . . . };

All sequentializations are considered to be functionally equivalent if they comply with a set of given sequentialization rules. The code generator used in the present embodiment generates source code for function block diagrams which adhere to these rules. The exchange of data between function blocks within one function block diagram is strictly defined and uses dedicated objects for storing this data.

Equivalence checking of function block diagrams can be used as a formal procedure of verifying that the code generated from function block diagrams behaves exactly as specified in terms of a circuitry on function block diagrams for any sequence of input signals or a formal procedure of verifying that one set of code generated from function block diagrams behaves exactly as another set.

In order to compare function block diagrams based on the dataflow graphs they implement, the respective code is transformed into such a directed graph.

In FIG. 3, a first set of three pieces of source code 70, 74, 78 generated from function block diagrams in a transformation step 82 is transformed into a first data flow graph 86. A second set of three pieces of source code 90, 94, 98 generated from function block diagram is in a transformation step 102 transformed into a second data flow graph 106. In a comparing step 110, the data flow graphs 86, 106 are compared. If they are identical, the equivalence of the group of source codes 70, 74, 78 and the group of source codes 90, 94, 98 is asserted.

When comparing two directed graphs, by definition the graphs are equivalent if the two sets V (vertices) and A (nodes) are the same in both graphs. Such a comparison requires a unique identification of each node. With the invented method the nodes can be uniquely identified by adding the nodes type, functionally relevant properties of the node and the transitive closure of all node inputs to the identification of each node.

A graph describing the logics of a function block diagram preferably consists of the following node types:

function block nodes, representing the “body” of a function block;
function block port nodes, representing input or output ports of function blocks;
signal negator nodes, representing the negation of an analog or binary or other type of signal connected at a port of a function block; and
signal nodes, representing cross-diagram signals or signals assigned to I/O modules.

Other attributes of function block diagrams which are relevant for the implemented functionality are modelled as properties of the graph's nodes. The following attributes are preferably taken into account.

For function block nodes:

the function block's type; and

functionally relevant engineered parameter values.

For function block port nodes:

the direction of the port (input or output), and

a identification of the port of the respective function block.

The dataflow between the engineered function blocks, function block diagrams and/or I/O modules is modelled by the directed edges which connect the nodes of the graph.

By creating a dataflow graph using the above mentioned nodes, their properties and interconnections of a function block diagram, the functionality implemented by the function block diagram can be modeled and the resulting graph can be compared to other graphs by comparing the contained nodes and edges

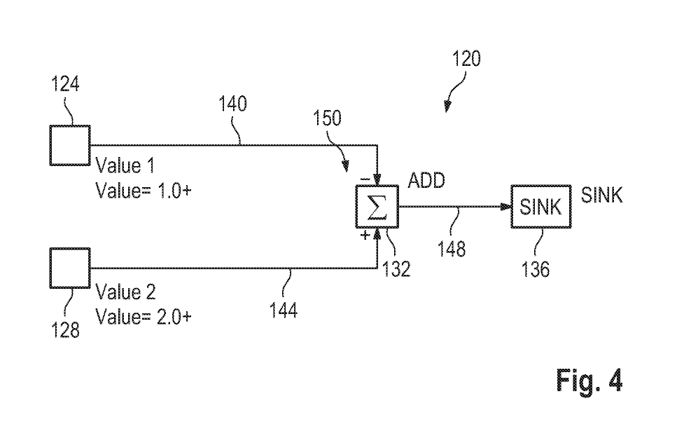

FIG. 4 shows a very simple function block diagram 120 containing four function blocks 124, 128, 132, 136, three connection lines 140, 144, 148 and one signal negation 150 at the upper input of the block 132 which is an ADD block, adding the negated signal transmitted from block 124 via connection line 140 and the signal transmitted from block 128 via connection line 144.

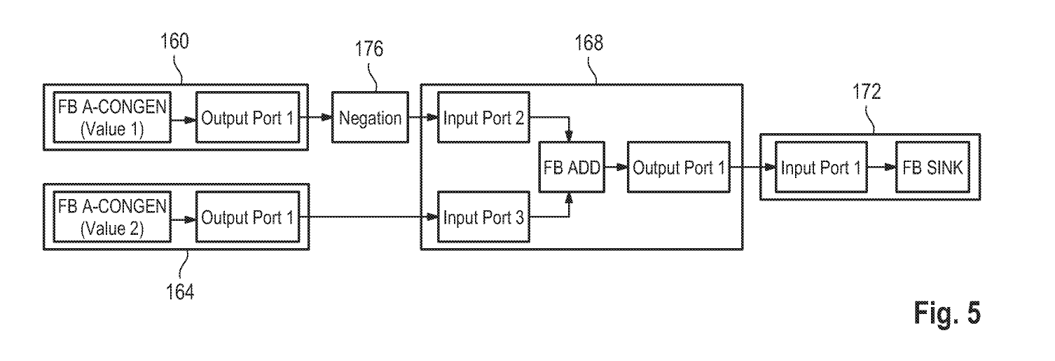

A visual representation of a graph modeling this function block diagram 120 is shown in FIG. 5. The boxes 160, 164, 168, 172 only mark the function block boundaries and do not model any nodes within the graph. The box 176 represents the signal negation 150 shown in FIG. 4.

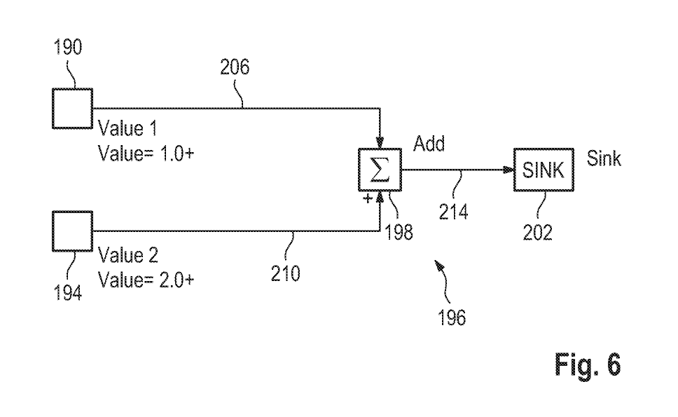

FIG. 6 shows another simple diagram 196, implementing a slightly different logic. It contains four function blocks 190, 194, 198, 202, three connection lines 206, 210, 214 but is missing the signal negation at the input of block 198 which is an ADD block. The missing signal negation is the only difference between diagrams 120 and 196.

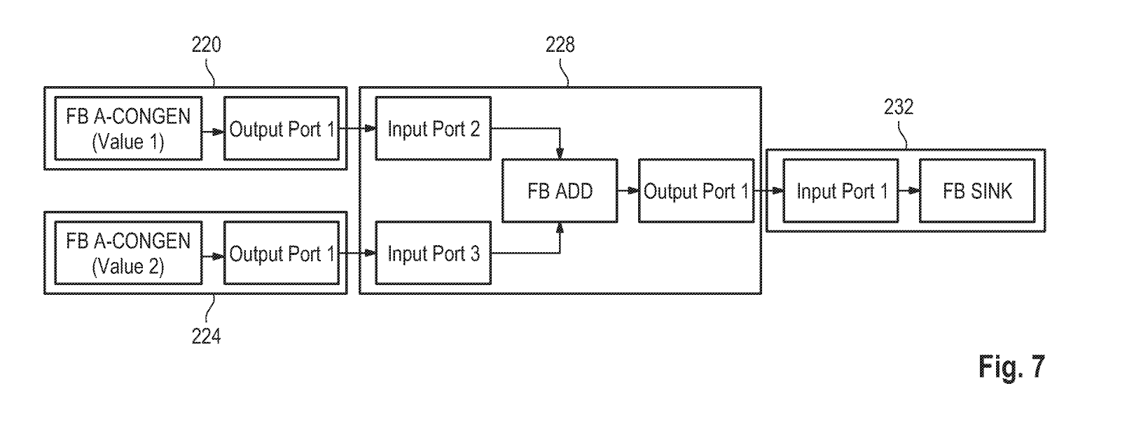

The corresponding graph is displayed in FIG. 7. The boxes 220, 224, 228, 232 only mark the function block boundaries and do not model any nodes within the graph. The identification of the nodes contained within the graphs has to include the above named properties as well as the transitive closure of inputs of the nodes. The following example shows a more formal representation of the nodes shown in FIG. 7 including hierarchical information about the nodes inputs. For easier reading the example does not contain any other functional properties within the node identifiers.

A-CONGEN( )

Out1(A-CONGEN( )

A-CONGEN( )

Out1(A-CONGEN( )

In2(Out1(A-CONGEN( )))

In3(Out1(A-CONGEN( ))

ADD(In2(Out1(A-CONGEN( ))),In3(Out1(A-CONGEN( )))

Out1(ADD(In2(Out1(A-CONGEN( ))),In3(Out1(A-CONGEN( ))))

In1(Out1(ADD(In2(Out1(A-CONGEN( ))),In3(Out1(A-CONGEN( )))))

SINK(In1(Out1(ADD(In2(Out1(A-CONGEN( ))),In3(Out1(ACONGEN( ))))))

Combining such a representation of nodes with all relevant functional properties allows a unique identification of each node regarding the functionality implemented using this node.

Note: Looking at the example above, one can see that two functional equivalent nodes might have the same identifier, which is absolutely correct. For the example this is true for the two A-CONGEN function blocks and their output signals. In case they use different parameterization, the identification would differ due to these functional parameters.

When comparing the two graphs of FIGS. 5 and 7, the set of contained nodes differs by the missing negator node. Additionally, the set of contained edges differs too, due to the missing node. The equivalence check based on the method according to the present invention preferably does not consider attributes that have no impact on the behavior of a function block diagram, such as:

position and order the function blocks are drawn on the function block diagram,
how connection lines are drawn (routing, including connectors across diagram pages), or
position of cross-diagram signals in the diagram's input and output area.

Those are purely graphical attributes used for visual display of the function block diagrams and have no effect on the generated code's structure.

Using this method, each instance of function block diagrams can be transformed into a unique dataflow based graph using the functional relevant attributes listed above. By using only functional relevant attributes of function block diagrams for this transformation, the resulting graph representations can be compared. This yields a proof that two function block diagrams are functionally equivalent if their graph representations are identical.

When comparing multiple diagrams which are interconnected using signals, the data flow graphs are preferably analyzed across diagram boundaries. This means that differences in the interconnection of diagrams are detected, too. When evaluating the interconnections between function block diagrams, it is checked whether the compared signals have an equivalent source and destination node

The implemented method preferably allows the user to define where each set of function block diagrams shall be read from. This enables the user to specify either one code generation directory or two separate code generation directories for the comparison. The method is preferably used for:

two sets of diagrams from one version of an application, for example for comparing diagrams between redundancies;
two sets of diagrams from two versions of the same application, for example to check that only planned changes where introduced, or even
two sets of diagrams from two different applications, for example to check that copied diagrams were introduced correctly.

Attributes marked as optionally, are only preferably processed when explicitly requested by the user when starting the comparison. By default these attributes are ignored.

1. A method for checking functional equivalence of two pieces of software for control systems and engineered from function block diagrams with a plurality of interconnected function blocks, which comprises the steps of:
a) generating a first instance of compilable source code from a first plurality of function diagrams by virtue of a first code generator obeying to a first set of sequentialization rules;
b) parsing the first instance of the compilable source code and identifying a first set of all function block I/O ports and junction points (nodes) and a first set of all connections between them (arcs) of data flow;
c) using information from the step b) to reconstruct a first data flow graph of the first instance of the compilable source code in an upstream direction;
d) generating a second instance of the compilable source code from a second plurality of function block diagrams by virtue of a same or a second code generator obeying a second set of sequentialization rules;
e) parsing the second instance of the compilable source code and identifying a second set of all function block I/O ports and junction points (nodes) and a second set of all connections between them (arcs) of the data flow;
f) using information from the step e) to reconstruct a second data flow graph of the second instance of the compilable source code in the upstream direction; and
g) comparing the first data flow graph and the second data flow graph with each other, node by node, and thereby checking if a transitive closure of input up to that node in the second instance of the compilable source code is a same as in the first instance of the compilable source code.

2. The method according to claim 1, wherein the second set of sequentialization rules is identical to the first set of sequentialization rules.

3. The method according to claim 1, wherein the reconstructing of the first data flow graph in the upstream direction further comprises identifying all loops and replacing them with a placeholder such that an infinite recursion is stopped at loops' delay nodes.

4. The method according to claim 1, wherein the reconstructing of the second data flow graph in the upstream direction further comprises identifying all loops and replacing them with a placeholder such that an infinite recursion is stopped at loops' delay nodes.

5. The method according to claim 1, wherein an equivalence of the two pieces of software is determined by checking, if for each node, the transitive closure of input up to that node in the second instance of the compilable source code is a same as in the first instance of the compilable source code.

6. The method according to claim 1, wherein at least one of the first or second plurality of function block diagrams by virtue of the first code generator is generated into source code written in C programming language.

7. The method according to claim 1, wherein:
the first and/or the second plurality of function block diagram source codes has at least one element selected from the group consisting of a delay block, a non-delay block, and a negator; and
the first and/or the second sequentialization complies with defined sequentialization rules.

8. The method according to claim 1, wherein at least one of the first data flow graph or the second data flow graph comprises nodes of the following types:
first function block nodes, representing a body of a function block;
second function block port nodes, representing input or output ports of function blocks;
signal negator nodes, representing a negation of an analog or binary or another type of signal connected at a port of the function block; and
signal nodes, representing cross-diagram signals or signals assigned to I/O modules.

9. The method according to claim 8, wherein:
the first and second function block nodes contain as attributes, respectively, a function block type and functionally relevant engineered parameter values; and
the function block port nodes contain as attributes, respectively, a direction of the port (input or output for the function block) and an identification of the port of the respective function block.

10. The method according to claim 1, wherein the method is employed for a safety control system in a nuclear power plant.

11. The method according to claim 1, wherein the method is employed for a safety control system containing several redundant divisions, each division executing at least one safety function specified in at least one function block diagram.

12. A non-transitory computer-readable storage device containing computer executable instructions to perform operations for checking functional equivalence of two pieces of software for control systems, the operations comprising a method according to claim 1.

13. A non-transitory computer-readable storage medium containing computer executable instructions which, when loaded into a memory of and executed on a computer, enable and/or cause the computer to perform operations for checking a functional equivalence of two pieces of software for control systems, the operations comprising a method according to claim 1.

14. A computer program product, which is stored on a non-transitory computer-readable medium and can be loaded directly into a memory of a computer, comprises software code sections which when executed on the computer enables and/or causes said computer to perform a method according to claim 1.

15. A computer, comprising:
memory having stored thereon software code sections which when executed on the computer enable and/or cause the computer to perform a method according to claim 1.
